(19) United States
(12) Patent Application Publication
(10) Pub. No.: US 2020/0097813 A1
(43) Pub. Date: Mar. 26, 2020

(54) DEEP LEARNING MODEL FOR PROBABILISTIC FORECAST OF CONTINUOUS MANUFACTURING PROCESS

(71) Applicant: International Business Machines Corporation, Armonk, NY (US)

(72) Inventors: Kyong Min Yeo, Scarsdale, NY (US); Igor Melnyk, White Plains, NY (US); Nam H Nguyen, Pleasantville, NY (US); Tsuyoshi Ide, Harrison, NY (US); Jayant R. Kalagnanam, Briarcliff Manor, NY (US)

(21) Appl. No.: 16/142,812

(22) Filed: Sep. 26, 2018

(51) Int. Cl. G06N 3/08; G06N 7/00

(52) U.S. Cl. CPC G06N 3/08; G06N 7/005

(57) ABSTRACT

A computer-implemented method for controlling a manufacturing process. A non-limiting example of the computer-implemented method includes using a processor to perform discretization modeling of a continuous probability distribution to yield a prediction of a future probability distribution. Next, the method uses the processor to impose a smoothness condition on the predicted probability distribution. The method using the processor to perform a multi-step forecast of the probability distribution to create a predicted probability density function. The method uses the predicted probability density function as an input to a process control system and uses the processor to control a process using the predicted probability density function.

### STATEMENT REGARDING PRIOR DISCLOSURES BY THE INVENTOR OR A JOINT INVENTOR

The following disclosures are submitted under 35 U.S.C. 102(b)(1)(A): DISCLOSURES: Model-free Prediction of Noisy Chaotic Time Series by Deep Learning, Kyongmin Yeo, Oct. 5, 2017, 5 pages; Learning Temporal Evolution of Probability Distribution with Recurrent Neural Network, Kyongmin Yeo, Oct. 27, 2017, 18 pages; Deep Learning Algorithm for Data-Driven Simulation of Noisy Dynamical System, Kyongmin Yeo, Igor Melnyk, Feb. 22, 2018, 37 pages; and Forecasting Probability Distribution of Non-Linear Time Series, Kyongmin Yeo, Igor Melnyk, Nam Nguyen, and Eun Kyung Lee, Feb. 10, 2018, 4 pages.

### BACKGROUND

The present invention generally relates to deep learning models, and more specifically, to a deep learning model for probabilistic forecast of continuous manufacturing process.

In cognitive manufacturing, one of the key elements is to develop an accurate model to make a forecast of the key state variables by exploiting the observations from a sensor network. However, the observation from a sensor network, including the measurement of key state variables, is a stochastic process due to the aleatoric variability, such as sensor noise, natural variability in the materials, mechanical noise, and so on.

### SUMMARY

Embodiments of the present invention are directed to a computer-implemented method for controlling a manufacturing process. A non-limiting example of the computer-implemented method includes discretization modeling of a continuous probability distribution to yield a prediction of a future probability distribution. Next, the method imposes a smoothness condition on the predicted future probability distribution. The method performs a multi-step forecast of the predicted future probability distribution to create a predicted probability density function over the forecast horizon. The method uses the predicted probability density function as an input to a process control system and controls a process using the predicted probability density function.

Embodiments of the present invention are directed to a system controlling a manufacturing process. A non-limiting example of the system includes a system, including: a memory and a processor coupled to the memory. The processor is operable to execute instructions stored in the memory. The instructions cause the processor to train a discretization model for a continuous probability distribution to yield a prediction of a future probability distribution. The instructions further cause the processor to impose a smoothness condition on the predicted future probability distribution and perform a multi-step forecast of the probability distribution to create a predicted probability density function over the forecast horizon. The instructions also cause the processor to use the predicted probability density function as an input to a process control system and control a process using the predicted probability density function.

Embodiments of the invention are directed to a computer program product for controlling a manufacturing process, the computer program product including a computer readable storage medium having program instructions embodied therewith. The program instructions are executable by a processor to cause the processor to perform a method. A non-limiting example of the method includes discretization modeling of a continuous probability distribution to yield a prediction of a future probability distribution. Next, the method imposes a smoothness condition on the predicted future probability distribution. The method performs a multi-step forecast of the probability distribution to create a predicted probability density function. The method uses the predicted probability density function as an input to a process control system and controls a process using the predicted probability density function.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an illustrative cloud computing environment according to embodiments of the present invention;

FIG. 2 depicts a set of functional abstraction layers provided by the cloud computing environment according to embodiments of the present invention;

FIG. 3. illustrates sensor data analytics in a typical artificial intelligence for a manufacturing scenario according to an embodiment of the present invention;

FIG. 4 depicts a graph of a numerical discretization of a probability density function p(y|x) according to embodiments of the present invention;

FIG. 5 illustrates an artificial neural network with a softmax function according to embodiments of the present invention;

FIG. 6 illustrates a process of regularizing probability distribution according to embodiments of the present invention;

FIG. 7 illustrates the training of a recurrent neural network (RNN) according to an embodiment of the present invention;

FIG. 8 illustrates the RNN according to an embodiment of the present invention;

FIG. 9 illustrates the deep learning model method to learn the time evolution of a probability distribution of a target variable according to embodiments of the present invention;

FIG. 10 illustrates a practical application of the deep learning model method to a first manufacturing process according to embodiments of the present invention; and

FIG. 11 illustrates a practical application of the deep learning model method to a second manufacturing process according to embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

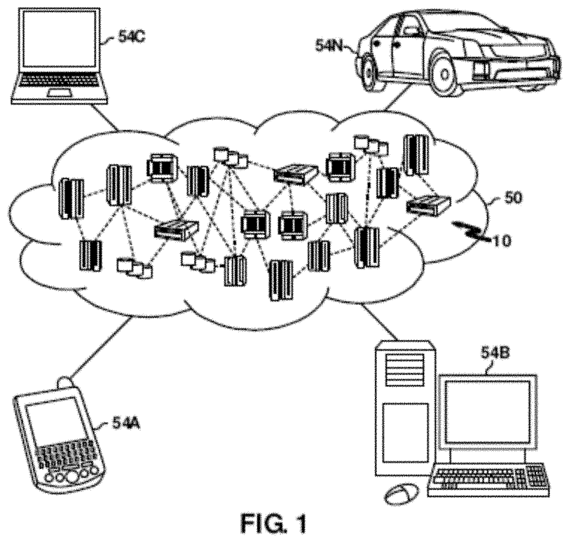

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

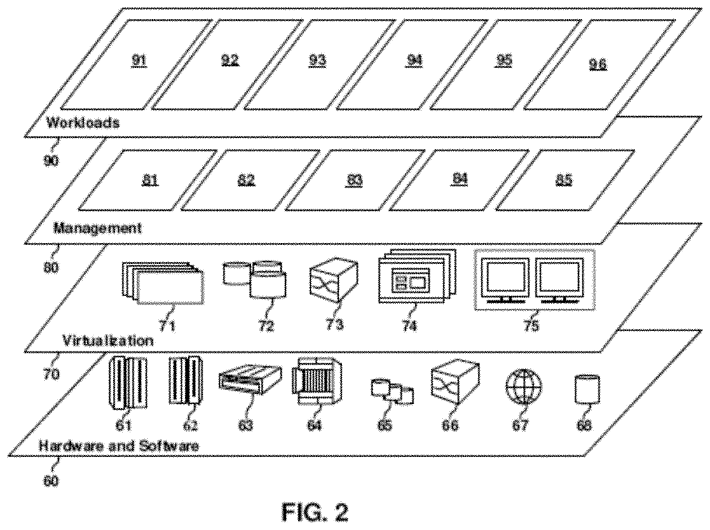

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and deep learning models for probabilistic forecasting of a continuous manufacturing process 96.

Turning now to an overview of technologies that are more specifically relevant to aspects of the invention, most of the conventional time series models assume at least partial knowledge of the governing equations, a linear transition of the state variables, or a parametric form of the noise process. So, those conventional models require a careful parameter tuning by experts and have limited accuracy for the modeling of complex engineering systems.

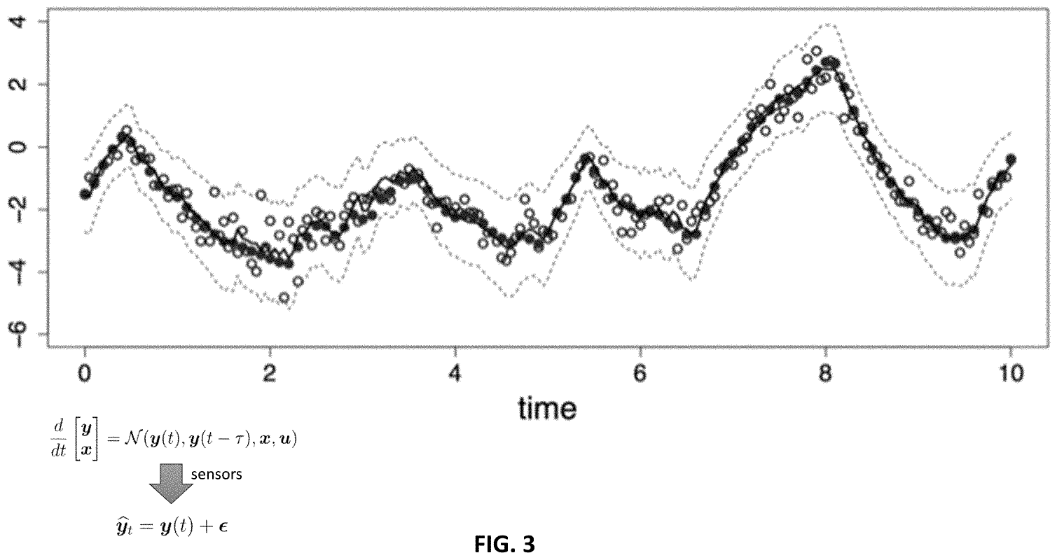

FIG. 3. illustrates sensor data analytics in a typical artificial intelligence for a manufacturing scenario according to an embodiment of the present invention. In a manufacturing scenario, there are a series of target variables (y), observations (x), and control sequences (u). There is some underlying complex physical process, which in most cases is unknown or partially known. The ground truth, y(t), is not observable. Only noisy, sensor measurements, which introduce uncertainty, are observed. The relationship of these variables can be expressed by the following equations:

$$\frac{d}{dt} [ \begin{matrix}y \\ x\end{matrix} ] = 𝒩 ( y ( t ) , y ( t - τ ) , x , u ) ,$$

and using sensors the observation, ŷ(t), is corrupted by a sensor noise, ϵ,

ŷₜ=y(t)+ϵ

FIG. 3. Illustrates typical time series data readings over time with the ground truth variables (y) shown as a solid line on the graph and the observations (ŷ) shown as hollow circles on the graph.

It is desirable to quantify the uncertainty and examine propagation of the uncertainty. Due to the noise process, sensor observation is a stochastic process. Precise prediction of a point value is not possible. Therefore, prediction should be made by a probability distribution, using the following equation:

p(ŷₜ₊₁|Ŷ_{0:t},U_{0:t}), where

Ŷ_{0:t}=(ŷₜ, . . . ,ŷ₀) and U_{0:t}=(uₜ, . . . ,u₀)

To predict propagation of uncertainty over time, the following equation is used:

$$p ( {\hat{y}}_{t + n} \vert \hat{Y} \text{?} , U \text{?} ) = \int … \int p ( {\hat{y}}_{i + n} \vert {h}_{t + n - 1} ) {\prod }_{\text{?} = 1}^{n - 1} p ( {H}_{t + i} \vert {H}_{t + i - 1} , {u}_{t + i} ) {dH}_{t + i} , \\ for n > 1 , \\ \text{?} \text{indicates text missing or illegible when filed}$$

Conventional machine learning models include dynamic linear models and auto-regressive models, for example. But, these rely on idealized assumptions of the distribution, for example, Gaussian distribution or the use of additive noise. They also provide a linear approximation of drift. Hence, these models have a limited capability for complex nonlinear dynamics.

Turning now to an overview of the aspects of the invention, one or more embodiments of the invention address the above-described shortcomings of the prior art by providing a method for developing a deep learning based predictive model for complex manufacturing processes from time series sensor data. The deep learning model is capable of predicting time evolution of probability distribution of key state variables without making assumptions on the parametric form of the underlying probability distribution or the system dynamics.

The above-described aspects of the invention address the shortcomings of the prior art by providing a deep learning model to learn the time evolution of a probability distribution of a target variable. It does this by: 1) a computer-implemented method for training and prediction methods for an artificial neural network for the discretization modeling of a continuous probability distribution; 2) a computer-implemented regularization method to impose a smoothness condition on the predicted probability distribution; and 3) using a computer-implemented Monte Carlo sampling method for a multiple-step forecast of the probability distribution. Finally, the computer-implemented method sends the predicted probability density function to a process control system or a control operator for control action.

First described is a computer-implemented method for training and prediction methods for an artificial neural network for the discretization modeling of a continuous probability distribution.

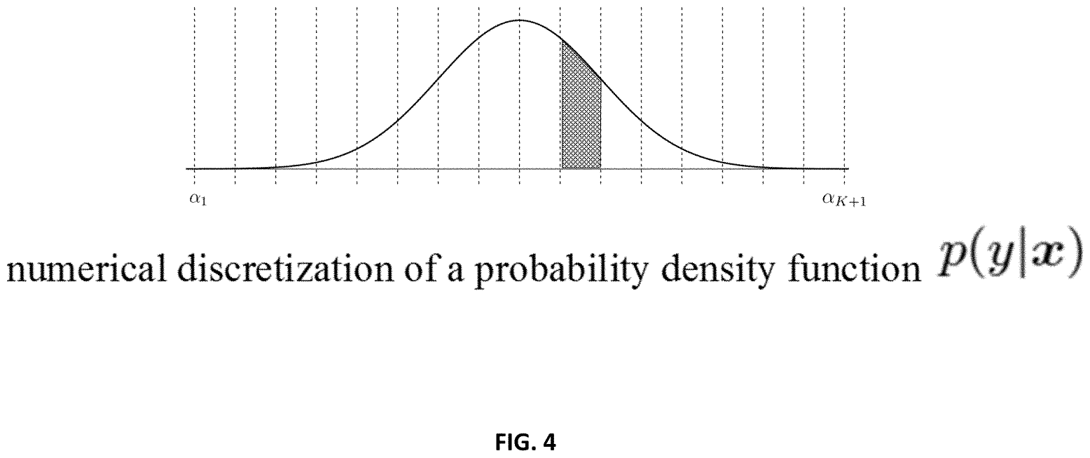

Turning now to a more detailed description of aspects of the present invention, FIG. 4 depicts a graph of a numerical discretization of a probability density function p(y|x) according to embodiments of the invention. It approximates a smooth density function by an artificial neural network. First a set of ordered real numbers is defined as follows: α₁<α₂< . . . <α_{K+1}.

Next, a mapping function, C, is defined as [symbol] : [symbol] → [symbol] +, such that C(y)=k, if αₖ<y≤αₖ₊₁.

Discrete probability is then be defined as:

P(k|x)=∫_{α}_{ₖ}^{α}^{ₖ₊₁}p(y|x)dy, for k=1, . . . ,K

This is illustrated by the graph in FIG. 4.

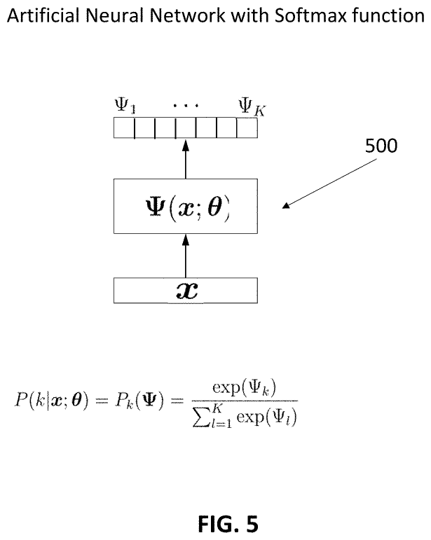

Next, a computer-implemented regularization method to impose a smoothness condition on the predicted probability distribution is described. FIG. 5 illustrates an artificial neural network with a softmax function according to embodiments of the invention. The simplified artificial neural network (“ANN”) with softmax function 500 is illustrated at a high level in the figure. The simplified illustration of an ANN illustrates the following formula:

$$P ( k \vert x ; θ ) = {P}_{k} ( Ψ ) = \frac{exp ( {Ψ}_{k} )}{{\sum }_{l = 1}^{K} exp ( {Ψ}_{l} )}$$

In order to train the ANN, there is initially a data conversion using the following formulae:

D={(yᵢ,xᵢ); i=1, . . . ,N}

[symbol]

D_{C}={(cᵢ,xᵢ); cᵢ=C(yᵢ), i=1, . . . ,N}

For a data likelihood function, a generalized Bernoullis distribution is used, as shown below:

$$P ( c \vert X ; θ ) = {\prod }_{n = 1}^{N} {\prod }_{k = 1}^{K} {P ( k \vert {x}_{n} ; θ )}^{{δ}_{c}} \text{?} \text{?}$$

$$\text{?} \text{indicates text missing or illegible when filed}$$

The model is then trained by minimizing cross-entropy loss, according the following formulae:

$$\begin{matrix}\begin{matrix} \hat{θ} = {arg min}_{θ ∈ {ℝ}^{{N}_{w}}} \{ - {\sum }_{n = 1}^{N} {\sum }_{k = 1}^{K} {δ}_{c} \text{?} log {P}_{k} ( Ψ ( {x}_{n} ; θ ) ) \} \\ = {arg min}_{θ ∈ {ℝ}^{{N}_{w}}} \{ - {\sum }_{n = 1}^{N} log P \text{?} ( Ψ ( {x}_{n} ; θ ) ) \}\end{matrix} & Equation ( 1 ) \\ \text{?} \text{indicates text missing or illegible when filed} & \end{matrix}$$

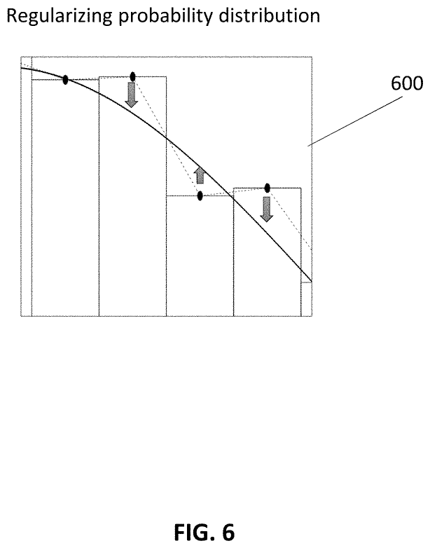

However, the standard cross-entropy loss function, shown in equation (1), does not guarantee smoothness of the estimated probability distribution. FIG. 6 illustrates a process of regularizing probability distribution according to embodiments of the present invention. Graph 600 illustrates graphically how the functions about to be discussed alter the distribution to move the points that are rough and not on the line onto a smooth line.

First, a roughness measure of the probability distribution is defined as follows:

[symbol]

=∫[pⁿ(y)]²dy

Next, from the Taylor expansion of the above equation and the discrete approximations,

$$p ( {α}_{k + 1 / 2} \vert x ) = \frac{1}{{Δ}_{k}} {P}_{k} ( x ) + O ( {Δ}_{k}^{2} )$$

and pⁿ(α_{1/2}|x)≃LP,

$$L = [ \begin{matrix}{l}_{1 a} & {l}_{1 b} & {l}_{1 c} & 0 & … & 0 \\ 0 & {l}_{2 a} & {l}_{2 b} & {l}_{2 c} & … & 0 \\ … & … & … & … & … & … \\ 0 & … & 0 & {l}_{( K - 2 ) a} & {l}_{( K - 2 ) b} & {l}_{( K - 2 ) c}\end{matrix} ]$$

$$with \text{:}$$

$${δ}_{i}^{-} = - \frac{1}{2} ( {Δ}_{i + 1} + {Δ}_{i} ) , {δ}_{i}^{+} = \frac{1}{2} ( {Δ}_{i + 2} + {Δ}_{i + 1} )$$

$${l}_{ia} = \frac{2}{{δ}_{i}^{-} ( {δ}_{i}^{-} - {δ}_{i}^{+} )} \frac{1}{{Δ}_{i}} {l}_{ic} = \frac{2}{{δ}_{i}^{+} ( {δ}_{i}^{+} - {δ}_{i}^{-} )} \frac{1}{{Δ}_{i + 2}}$$

$${l}_{ib} = \frac{2}{{δ}_{i}^{-} {δ}_{i}^{+}} \frac{1}{{Δ}_{i + 1}} ,$$

Now, a further refinement of equation (1) is made using the following equations:

$${D}_{ij} = {Δ}_{i + 1} {δ}_{ij} and$$

$${( LP )}^{T} D ( LP ) ≃ \int {[ {p}^{n} ( y ) ]}^{2} dy to yield$$

$${θ}^{*} = {arg min}_{θ ∈ {ℝ}^{{N}_{w}}} {\sum }_{n = 1}^{N} \{ {\sum }_{k = 1}^{K} - δ \text{?} log {P}_{k}^{n} + {λ ( {LP}^{n} )}^{T} D ( {LP}^{n} ) \}$$

$$\text{?} \text{indicates text missing or illegible when filed}$$

$${( LP )}^{T} D ( LP ) ≃ \int {[ {p}^{n} ( y ) ]}^{2} dy to yield$$

Next, a recurrent neural network (“RNN”) is used for the prediction of a probability distribution. An RNN is a class of artificial neural network where connections between nodes form a directed graph along a sequence. This allows it to exhibit temporal dynamic behavior for a time sequence. Unlike feedforward neural networks, RNNs can use their internal state (memory) to process sequences of inputs. Given noisy observation, previously discussed, Ŷ_{0:t}=(ŷₜ, . . . , ŷ₀), and exogenous forces, u_{0:t}=(uₜ, . . . , u₀), the probability distribution of the state of the system will be p(ŷₜ₊₁|Ŷ_{0:t}, U_{0:t}). The probability distribution will evolve over time to yield p(ŷₜ₊ₙ|Y_{0:t}, U_{0:t+n-1}).

In this case, the temporal gradient needs to be modeled. First the original data set is converted to a temporal difference data set using the following equations:

dŷₜ=ŷₜ₊₁−ŷₜ

[symbol]

ₒ={(ŷⁿ,uⁿ); n=1, . . . ,N} [symbol] [symbol] _{T}={(dŷⁿ,ŷⁿ,uⁿ); n=1, . . . ,N}

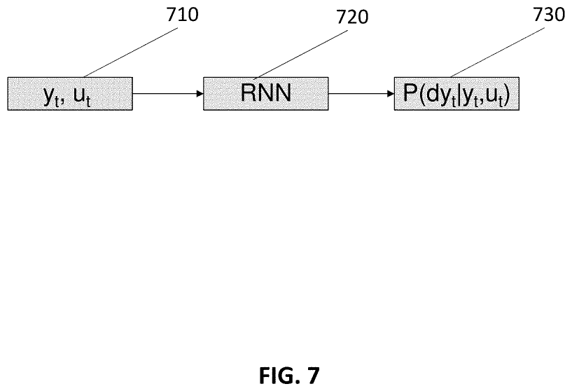

Next, the RNN is trained to predict dyₜ instead of yₜ. This is illustrated in FIG. 7 which illustrates the training of an RNN according to an embodiment of the present invention. Inputs yₜ and uₜ (block 710) if fed into an RNN 720 which yields a predicted output 730.

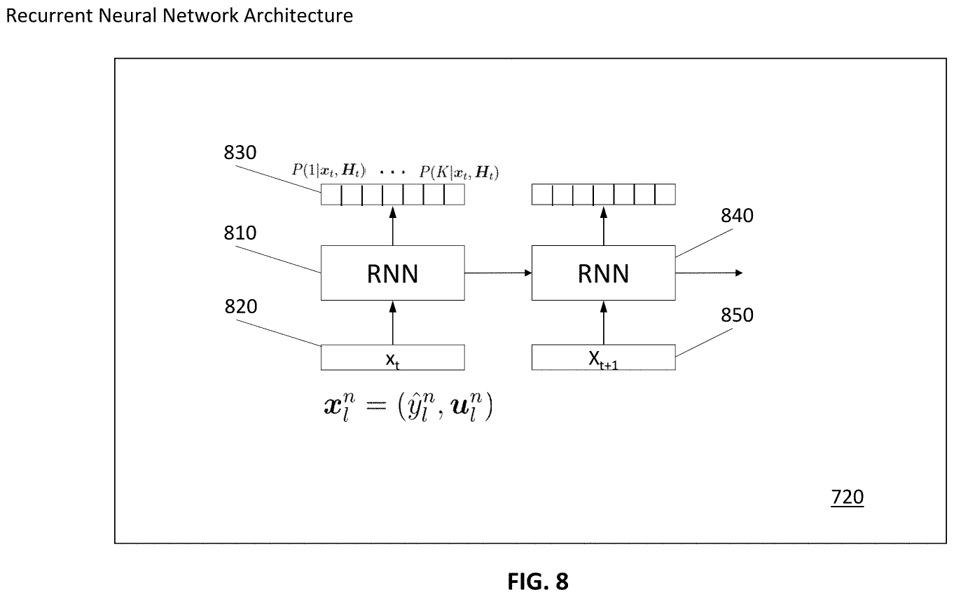

FIG. 8 illustrates the RNN 710 according to an embodiment of the present invention. First stage of RNN 710 includes first stage RNN 810, which has input Xₜ 820. First stage RNN 810 has an output P(1|xₜ, Hₜ) . . . P(K|xₜ, Hₜ) 830. Here, Hₜ denotes the internal state of RNN 810. The internal state of RNN 810 is also fed into second stage RNN 840 which also receives input Xₜ₊₁ 850. There may be further stages of the RNN that are not shown in this figure.

In order to solve for the probability distribution, there is initially data conversion and then regularization of cross-entropy.

Data conversion uses the following formula:

[symbol]

_{T}={(dŷⁿ,ŷⁿ,uⁿ); n=1, . . . ,N}

[symbol]

[symbol]

_{c}={(cⁿ,ŷⁿ,uⁿ); cⁿ= [symbol] (dŷⁿ), n=1, . . . ,N}

Regularization of cross-entropy uses the following formulae:

$$P ( C \vert X ; θ ) = {\prod }_{n = 1}^{N} {\prod }_{\text{?}}^{T - 1} {\prod }_{k = 1}^{K} {P ( k \vert {x}_{l}^{n} ; {H}_{l - 1}^{n} ; θ )}^{{δ}_{{c}_{i + 1}^{n}} k} , where$$

$${x}_{l}^{n} = ( {\hat{y}}_{l}^{n} , {u}_{i}^{n} )$$

$$L ( θ ) = {\sum }_{l = 1}^{T - 1} {l}_{l}^{*} ( θ )$$

$${l}_{l}^{*} ( θ ) = {\sum }_{n = 1}^{N} \{ {\sum }_{k = 1}^{K} - δ \text{?} log {P}_{i + 1}^{n} \text{?} + {λP}_{t + 1}^{n} {}_{}^{T}{MP}{}_{i + 1}^{n} \} , where M = {L}^{T} DL$$

$$\text{?} \text{indicates text missing or illegible when filed}$$

Finally, a multi-step forecast is made using a Monte Carlo method. An exemplary algorithm is illustrated below:

Algorithm 1 Monte Carlo method for a multi-step forecast

```
Initialize RNN states: H₀ = 0
Perform a sequential update of RNN up to time t.
for i = 1, t do
  Hᵢ = ψ_{H}(Hₜ₋₁, [symbol]    )
end for
Make N, replicas of the internal state
        Hᵢ⁽¹⁾ = . . . = Hᵢ⁽ [symbol] ⁾ = Hₜ
for j = 1, n do
  for i = 1, N_{c} do
    Compute the predictive distribution of ŷₜ₊ᵢ^{(s)} for each sample
          Pₜ₊ⱼ⁽ⁱ⁾ = Ψ_{y}(Hₜ₊ⱼ₋₁⁽ⁱ⁾)
    Draw ŷₜ₊ⱼ⁽ⁱ⁾ from the computed distribution:
      1. Draw the class label from the discrete distribution: k⁽ⁱ⁾ ~ Pₜ₊ⱼ⁽ⁱ⁾
      2. Draw ŷₜ₊ⱼ⁽ⁱ⁾ in [symbol] [symbol]      : ŷₜ₊ⱼ⁽⁰⁾ ~ [symbol]   ( [symbol]   )
    Update the internal state of RNN:
        Hₜ₊ⱼ⁽ⁱ⁾ = ψ_{H}(Hₜ₊ⱼ₋₁⁽ⁱ⁾,ŷₜ₊ⱼ⁽ⁱ⁾, uₜ₊ⱼ)
  end for
end for [symbol]
indicates data missing or illegible when filed
```

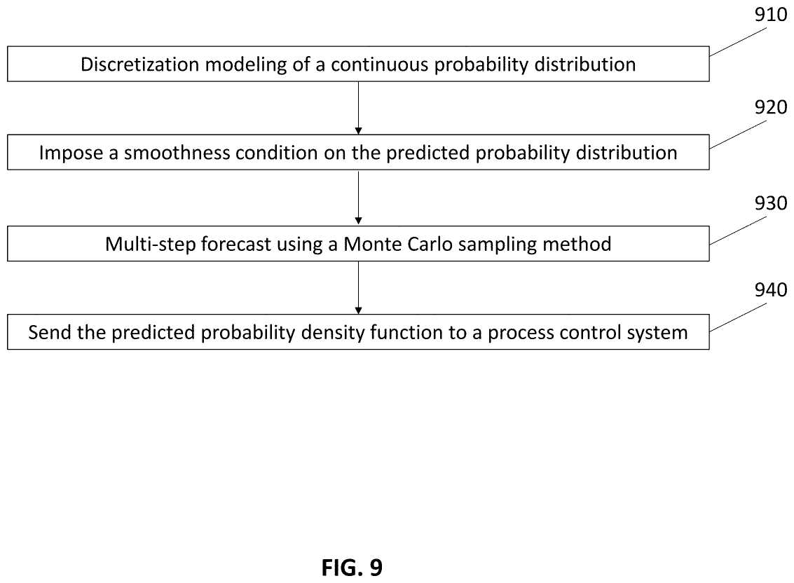

In summary, FIG. 9 illustrates the deep learning model method to learn the time evolution of a probability distribution of a target variable according to embodiments of the present invention. First, a computer-implemented method for training and prediction methods for an artificial neural network for the discretization modeling of a continuous probability distribution is performed (stage 910). Next, a computer-implemented regularization method to impose a smoothness condition on the predicted probability distribution is performed (stage 920). Next, a computer-implemented Monte Carlo sampling method for a multiple-step forecast of the probability distribution is performed. (stage 930). Finally, the computer-implemented method sends the predicted probability density function to a process control system for control action (stage 940).

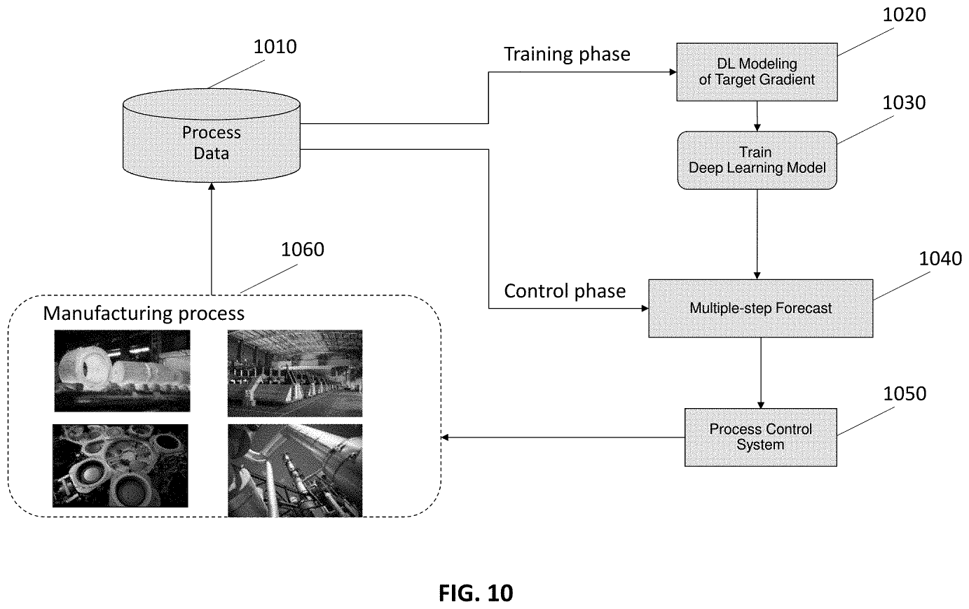

FIG. 10 illustrates a practical application of the deep learning model method to a first manufacturing process according to embodiments of the present invention. Process data 1010 is received from a manufacturing process 1060. The process data 1010 is used for deep learning modeling of a target gradient 1020 as previously described above. The output of the model 1020 is used to train the deep learning model described above. In a control phase, the deep learning model RNN 1030 is used in conjunction with process data 1010 used in a control phase to make a multi-step forecast 1040. The output of the multi-step forecast 1040 is input to a process control system 1050 to control the manufacturing process 1060.

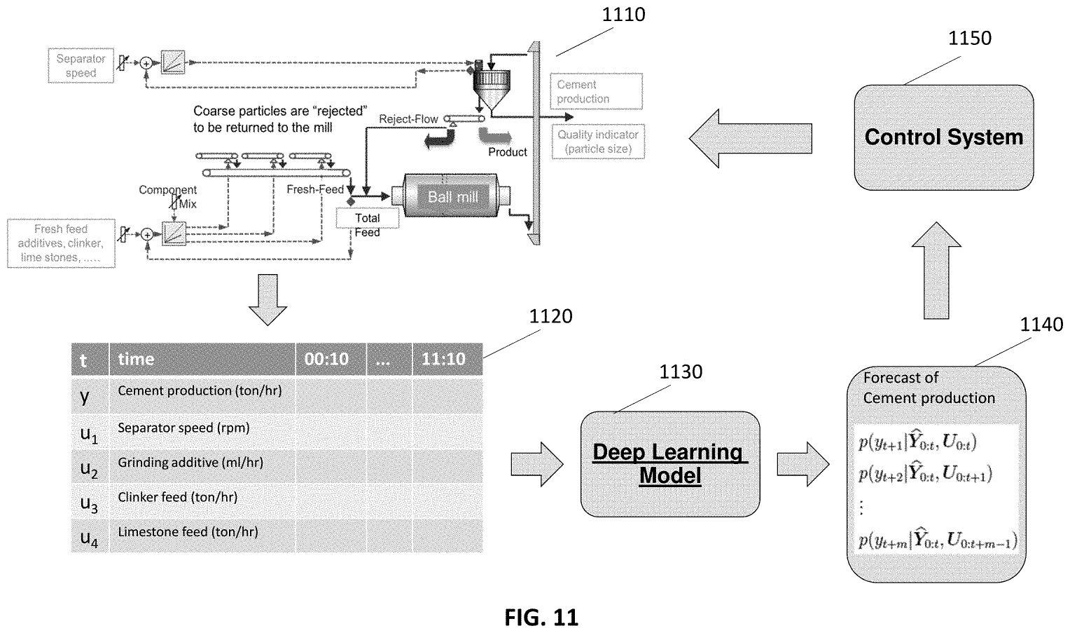

FIG. 11 illustrates a practical application of deep learning model the method to a second manufacturing process according to embodiments of the present invention. A manufacturing process for cement production facility 1110 is illustrated. The desired output and input variables are gathered and analyzed at 1120. The stored process data 1120 is provided to the deep learning model 1130, initially in a training phase and later in a control phase. The deep learning model 1130, following training, is used to forecast cement production as a probability function at future periods in time with a Monte Carlo simulation run at 1140. The output of the forecast is used to feed values into control system 1150 which controls the cement production facility 1110.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
using a processor to perform discretization modeling of a continuous probability distribution to yield a prediction of a future probability distribution;
using the processor to impose a smoothness condition on the prediction of the future probability distribution;
using the processor to perform a multi-step forecast of the prediction of the future probability distribution to create a predicted probability density function for a forecast horizon;
using the predicted probability density function for the forecast horizon as an input to a process control system; and
using the processor to control a process using the predicted probability density function for the forecast horizon.

2. The computer-implemented method of claim 1, wherein discretization modeling of a continuous probability distribution function further comprises using a processor to receive a series of target variables (y), auxiliary observations (x), and control sequences (u).

3. The computer-implemented method of claim 2, wherein discretization modeling of a continuous probability distribution function is defined by the formula
P(k|x)=∫_{α}_{ₖ}^{α}^{ₖ₊₁}p(y|x)dy, for k=1, . . . ,K.

4. The computer-implemented method of claim 1, wherein imposing a smoothness condition on the predicted probability distribution comprises using an artificial neural network with softmax function and a regularized cross-entropy loss.

5. The computer-implemented method of claim 4, wherein the artificial neural network is initially trained.

6. The computer-implemented method of claim 5, wherein the artificial neural network is trained by minimizing regularized cross-entropy loss.

7. The computer-implemented method of claim 1, further comprising using a recurrent neural network for prediction of the future probability distribution.

8. The computer-implemented method of claim 1, wherein performing a multi-step forecast of the probability distribution to create a predicted probability density function uses a Monte Carlo method.

9. A system comprising:
a memory;
a processor coupled to the memory, the processor operable to execute instructions stored in the memory, the instructions causing the processor to:
perform discretization modeling of a continuous probability distribution to yield a prediction of a future probability distribution;
impose a smoothness condition on the predicted future probability distribution;
perform a multi-step forecast of the predicted future probability distribution to create a predicted probability density function;
use the predicted probability density function as an input to a process control system; and
control a process using the predicted probability density function.

10. The system of claim 9, wherein discretization modeling of a continuous probability distribution function further comprises receiving a series of target variables (y), auxiliary observations (x), and control sequences (u).

11. The system of claim 10, wherein discretization modeling of a continuous probability distribution function is defined by the formula
P(k|x)=∫_{α}_{ₖ}^{α}^{ₖ₊₁}p(y|x)dy, for k=1, . . . ,K.

12. The system of claim 9, wherein imposing a smoothness condition on the predicted future probability distribution comprises using an artificial neural network with softmax function and a regularized cross-entropy loss.

13. The system of claim 12, wherein the artificial neural network is initially trained.

14. The system of claim 13, wherein the artificial neural network is trained by minimizing regularized cross-entropy loss.

15. The system of claim 9 further comprising a recurrent neural network for prediction of the future probability distribution.

16. The system of claim 9, wherein performing a multi-step forecast of the predicted future probability distribution to create a predicted probability density function uses a Monte Carlo method to perform the multi-step forecast.

17. A computer program product for controlling a process comprising a computer readable storage medium having program instructions embodied therewith, the program instructions executable by a computer, to cause the computer to perform a method comprising:
discretization modeling, by a processor, of a continuous probability distribution to yield a prediction of a future probability distribution;
imposing, by the processor, a smoothness condition on the predicted future probability distribution;
performing, by the processor, a multi-step forecast of the predicted future probability distribution to create a predicted probability density function;
using, by the processor, the predicted probability density function as an input to a process control system; and
controlling, by the processor, a process using the predicted probability density function.

18. The computer program product of claim 17, wherein discretization modeling of a continuous probability distribution function further comprises receiving, by the processor, a series of target variables (y), auxiliary observations (x), and control sequences (u).

19. The computer program product of claim 18, wherein discretization modeling of a continuous probability distribution function is defined by the formula
P(k|x)=∫_{α}_{ₖ}^{α}^{ₖ₊₁}p(y|x)dy, for k=1, . . . ,K.

20. The computer program product of claim 17, wherein imposing a smoothness condition on the predicted probability distribution comprises using, by the processor, an artificial neural network with softmax function and a regularized cross entropy loss.
